(19) United States
(12) Patent Application Publication
(10) Pub. No.: US 2012/0103789 A1
(43) Pub. Date: May 3, 2012

(54) Greener Synthesis of Nanoparticles Using Fine Tuned Hydrothermal Routes

(75) Inventor: Mathew Maye, Binghamton, NY (US)

(73) Assignee: SYRACUSE UNIVERSITY, Syracuse, NY (US)

(21) Appl. No.: 13/284,385

(22) Filed: Oct. 28, 2011

Related U.S. Application Data
(60) Provisional application No. 61/407,490, filed on Oct. 28, 2010.

(51) Int. Cl. B01J 19/12; B82Y 40/00; B82Y 99/00

(52) U.S. Cl. 204/157.43; 977/774; 977/896

(57) ABSTRACT

The synthesis of energy and sensor relevant nanomaterials that involves the colloidal synthesis of quantum dots (e.g. CdSe, CdS, ZnS, CdSe/ZnS) under well-controlled hydrothermal conditions (100-200 degrees C.) using simple inorganic precursors. The resulting nanomaterials are of high quality, and are easily processed depending upon application, and their synthesis is scalable. Scalability is provided by the use of a synthetic microwave reactor, which employs dielectric heating for the rapid and controllable heating.

### CROSS-REFERENCE TO RELATED APPLICATIONS

This application claims priority to U.S. Provisional Patent Application Ser. No. 61/407,490 filed on Oct. 10, 2010 and entitled “Greener Synthesis of Nanoparticles Using Fine Tuned Hydrothermal Routes,” the entirety of which is hereby incorporated by reference herein.

### BACKGROUND OF THE INVENTION

1. Field of the Invention

The present invention relates to nanoparticles and, more particularly, to the hydrothermal and solvothermal synthesis of plasmonic and photoluminescent nanomaterials using a microwave assisted processing and synthesis route.

2. Description of the Related Art

The field of soft-nanotechnology has emerged as a premier scientific discipline, catalyzed by work on wet chemical synthesis routes for colloidal nanoparticles, including semiconductive quantum dots (q-dots). Since the founding reports, the knowledge base of q-dot synthesis and their remarkable photophysical characteristics has grown rapidly. The approach for q-dot synthesis is synergy of traditional wet-chemical approaches using inorganic precursors, with that of solid-state processing, which utilizes high temperature annealing, nucleation and growth, and epitaxial deposition. Despite this synthetic progress, there are still a number of areas where research in needed. For instance, while the quantum confinement of excitons is sensitized greatly in organically encapsulated q-dots, thus leading to optimized quantum yields of >50%, this same encapsulation limits e-transport, limiting potential in photovoltaic efficiency for instance. In addition, this same encapsulation leads the q-dots to be notoriously challenging to functionalize for aqueous processing, such as those steps required for high coverage of biomaterials for self-assembly or sensing utility. In addition, the synthesis of q-dots is typically labor and energy intensive, requires copious amounts of organic solvent for purification, and requires high temperature for both reproducibility and q-dot crystallinity.

Along these lines, research has begun to revisit the synthesis of q-dots under aqueous conditions, the original fabrication route. One significant limitation of this approach is the inability to achieve the high temperatures required for processing, owing in large part to the limited reflux temperatures. The ability to synthesize semiconductive q-dots under aqueous conditions may allow for the better integration of the novel properties into a number of devices in a more straightforward manner. Such devices include, biodiagnostics, where biomaterials can be more easily attached, and in dye sensitized solar cells, where an aqueous q-dot dye sensitizer would facilitate both attachment to TiO2, as well as promote redox with an Iodine mediator.

Traditional routes to synthesize nanomaterials are both labor, energy, and reagent intensive. For example, the synthesis of a particular semiconductive quantum dot may require grams of reagents and solvents, and also high temperatures and long reaction times. The state of the art method to employ nanomaterials in applications that require aqueous conditions (such as in biotechnology) requires multiple synthetic steps to change the particles surface chemistry, which facilitates phase transfer from organic solvents (i.e. toluene) to aqueous buffers. At each step, nanomaterial yield is lost, as is the quality or solubility of the materials.

The use of q-dot nanomaterials in aqueous media, such as biosensing, imaging, and energy conversion typically requires multistep phase transfer routes based on tailoring surface chemistry. Such surface modification can lead to instability, and increased hydrodynamic diameters, which affect utility. Thus, the ability to synthesize q-dots under aqueous conditions with improved photophysical properties that are comparable to the state of the art would be very beneficial. One limitation to this is the availability of high temperatures is aqueous protocols, which limits size control and crystalline annealing.

One emerging protocol for the aqueous synthesis of nanomaterials is the use of microwave irradiation (MWI) as a heating source. Unlike traditional mantle or oil based heating which rely on conduction, convection, and radiation; MWI based heating affords direct energy transfer from MW electromagnetic radiation and the dipole moment of solvent, chemical, or material at high frequency. This dielectric heating acts simultaneously over the entire reaction volume, via absorption of energy (i.e., 10-1000 W) selectively to high dielectric materials, namely; dipole containing solvents or monomers. This allows for vastly decreased thermal gradients in a reaction, therefore providing a uniform thermal activation, which is ideal for nuclei formation and uniform growth for nanomaterials.

The interaction between a material and electromagnetic radiation is best described in terms of dielectric constants. Briefly, energy transfer from the microwave electromagnetic radiation can be described as a dielectric loss e″, which is dependent upon a materials dielectric constant e′ (e′=eᵣe_{O}, eᵣ=dielectric constant, e_{O}=permittivity). A dissipation factor, y□=e″/e′, where y is□the loss tangent, then broadly defines a materials dielectric heating. Such energy absorption is drastically enhanced due to the high frequency of the low-energy MWI.

Because the energy transferred from a 2.45 GHz alternating MWI source is only ˜0.3 cal/mol, increased number of monomer collisions and increased entropy are thought to account for increases in kinetics and yields. Kinetically, k=A exp(−ΔG_{Act}/RT), MWI has also been hypothesized to increase reaction kinetics via: (i) increasing the probability of impacts (A), and (ii) decreasing activation energy (ΔG_{Act}) due to entropic effects of the induced high frequency rotation¹⁸. Taken together these interactions lead to dramatically decreased reaction times, and increased yields. In addition, the opportunity does exist for MWI to induce a third, so-called non-equilibrium conditions, such a local heating, and super heating.

Such non-equilibrium affects are particularly interesting from a colloidal synthesis point of view, since the local temperature of the growing nuclei might be at much higher temperatures than the surrounding medium, either solvent or ligand shell. Not only would this increase reaction kinetics, it may also increase nanoparticle temperature above that of its melting point, which is possible since a nanomaterials melting temperature is drastically decreased at nanometer grain sizes. This may therefore affect crystallinity, and perhaps lead to interesting phase behavior of the nanocystal itself.

The use of MWI based heating is now the preferred method in industry, especially in the preparation of many commercially available small molecules, oligonucleotides, peptides, or polymers, which take advantage of automated synthesis at high throughput levels, for example. While the use of MWI in synthetic chemistry is well established, its use in solid-state, and colloidal chemistry is less understood by comparison.

One exciting opportunity that the MWI based heating affords is the potential for automation, high-throughput screening, and ease of scalability. In addition to MWI based aqueous one-pot synthesis of nanomaterials, the use of hydrothermal conditions has also been explored, but examples are much more limited. For instance, the synthesis of CdSe, CdTe, CdTe/ZnS, as well as FeS₂ has recently been shown under hydrothermal conditions. Hydrothermal processing is intriguing, as it provides the high temperatures typically required for crystalline annealing of the nanomaterial, especially those that require high temperature, such as q-dots. However, fine control of reaction kinetics or heating and cooling rates is challenged in hydrothermal routes, due in large part to experimental set-ups.

### BRIEF SUMMARY OF THE INVENTION

The present invention provides a system and method for the synthesis of CdSe, CdS q-dots, and CdTe q-dots under aqueous hydrothermal conditions with well-defined temperatures between 80-210° C. The present invention further involves tuning of the hydrothermal temperature (T_{H}) and kinetic ramping via the use of a synthetic microwave reactor (Discovery-S, CEM Inc). Moreover, this microwave assisted processing and synthesis (MAPS) route produces high quality, soluble, and easily functionalized q-dots in only 2-5 minutes, and is scalable up to a few hundred milliliters. This present method introduces a new route to chemically synthesize important nanomaterials via a “greener” method and also a method that may allow researchers to explore new phase regimes, and synthesis mechanisms. Importantly, the synthesized nanomaterials are produced in ultrapure water, allowing the method to be cost effective, environmentally green, and also to produce nanomaterials that are soluble in water, a critical step for future work in drug delivery, imaging, sensing, and energy conversion.

The “MAPS” routes dramatically decreases reaction times, allowing rapid achievement of the required synthesis temperatures (50-300 C.), and also provides a scalable platform. Most importantly, it allows the use of a fine-tunable “hydrothermal” synthesis route. In this route, water is heated above its boiling point due to the increase in pressure in a sealed tube. In the preferred system, heating is provided by a synthetic microwave reactor. The synthesis of nanomaterials under aqueous conditions also alleviates a number of problems with current technologies. Because materials are produced in water, they are more easily integrated into a number of biotechnology applications.

The present invention also encompasses the fabrication of highly emissive CdSe, CdSe/CdS, and CdSe/CdS/ZnS q-dots under fine-tuned hydrothermal conditions. The method of the present invention involves the use of a synthetic microwave reactor for dielectric heating that provides both kinetic control, and in-situ monitoring of temperature and pressure. Results indicate the dramatic improvement for core and core-shell q-dot luminescence at hydrothermal temperatures, as indicated by increased; monodispersity, quantum yields, q-dot brightness, and lifetimes.

The synthesis of CdSe cores, as well as CdSe/CdS, CdSe/ZnS, and CdSe/CdS/ZnS core/shell q-dots using hydrothermal conditions with well-defined temperatures between 120-210° C. The present invention provides the ability to rapidly tune hydrothermal temperature (T_{H}), kinetic ramping, and temperature quenching via the use of a synthetic microwave reactor (Discovery-S, CEM Inc). Moreover, the scalable MWI-based hydrothermal protocol of the present invention produces high quality, and easily functionalized q-dots in minutes. The MW reactor also serves to monitor growth conditions with in-situ monitoring of reaction temperature and pressures, thus facilitating highly fine-tunable and reproducible results.

### BRIEF DESCRIPTION OF THE SEVERAL VIEWS OF THE DRAWING(S)

The present invention will be more fully understood and appreciated by reading the following Detailed Description in conjunction with the accompanying drawings, where:

FIGS. 1A through 1C are a series of graphs of: the normalized PL emission (A), PL excitation and absorption (B) spectra for CdSe q-dot synthesized at TH=120° C., and (C) the dependence of q-dot synthesis TH and PL emission.

FIGS. 2A through 2B are a series of graphs of: (A) the PL emission of CdTe q-dots synthesized at TH=110 (i), 130 (ii), and 150 (iii) ° C.; and (C) the dependence of CdTe q-dot synthesis TH and PL emission.

FIG. 3 is a digital image of the synthetic setup along with representative graphs of temperature (T_{H}, b) and pressure (P_{H}, c) profiles measured in-situ during MAPS synthesis. Three regimes are tailored during synthesis, namely heating rate (i), stable T_{H} control (ii), and active cooling (iii) to quench growth.

FIG. 4 is a series of graphs of a representative UV-vis (a), photoluminescence emission (b), and excitation (c) spectra for CdSe q-dots synthesized at 60 (i), 90 (ii), 120 (iii), 150 (iv), and 180° C. (v). Spectra are normalized and offset for clarity.

FIG. 5 is a series of graphs of representative UV-vis (a) and photoluminescence emission (b) for as synthesized CdSe cores (i) and core/shell q-dots after CdS (ii), ZnS (iii), and CdSZnS (iv) shell growth at TH=120° C. (v).

FIG. 6 is a schematic illustration (a) of the synthesis strategy employed. Microwave irradition (MWI) based dielectric heating to hydrothermal temperatures allows for automated synthesis, high throughput, and in-situ monitoring of reaction temperature (b), and pressure (c) during hydrothermal qdot synthesis.

FIG. 7 is a series of graphs representing UV-vis absorption (a), PL emission (b) and PL excitation (c) spectra for CdSe qdots synthesized at 60 (i), 90 (ii), 120 (iii), 150 (iv), and 180° C. (v) with r=[Cd]:[Se]=4, and 5 minute reaction time (see FIG. 1b). An excitation of 400 nm was used for PL emission; each spectrum is normalized and offset for comparison.

FIG. 8 is a series of graphs showing a summary of T_{H} dependence on band edge absorption (l_{Abs}, a), PL emission (l_{PL}, b), and QY (c) for CdSe qdots prepared at r=8 (i), and 4 (ii).

FIG. 9 is a series of representative TEM micrographs and statistical analysis for CdSe qdots synthesized at T_{H}=120° C. (a,b) revealing average diameter of 3.4±0.6 nm (n=192), and at T_{H}=180 (c,d) revealing average diameter of 3.7±0.4 nm (n=150).

FIG. 10 is a series of graphs depicting: (a) TCSPC measurements CdSe prepared at 60 (i), 90 (ii), 120 (iii), 150 (iv), and 180° C. (v) at r=8, where an excitation of 420 nm was provided by a Ti:sapphire laser system with a 60 fs pulse, and a 45 ps instrument response function; and (b) A corresponding plot of calculated τ_{Ave} from TCSPC measurements indicating a systematic increase in τ_{Ave} with increased hydrothermal temperature.

FIG. 11 is representative set of FCS results for CdSe qdots fabricated at 150° C. (i) and a Rhodamine 110 (ii) standard normalized to qdot concentration in Figure (a). Fitting with a triplet diffusion model results in <N>˜17 qdots in the focal volume during measurement, with a diffusion constant <D>˜24.5 mm²/s. Compared with corresponding intensity time traces of FIG. 11(b), average qdot brightness is estimated. A corresponding plot of the trend between qdot brightness and processing temperature is show in Figure (c).

FIG. 12 is a representative set of graphs of the UV-vis (a) and PL emission (b) for CdSe-cores synthesized at 160° C. (i), and after CdS (ii), ZnS (iii), and CdS/ZnS (iv) shell growth at TH=120° C. The TCSPC results (c) for the as-synthesized CdSe-cores before (i) and after ZnS shell growth (ii) with 420 nm excitation.

FIG. 13 is series of representative TEM micrographs and statistical analysis for CdSe/ZnS qdots with CdSe cores synthesized at T_{H}=120° C. (a,b) revealing average diameter of 5.9±1.0 nm (n=110), and at T_{H}=180° C. revealing average diameter of 5.2±0.5 nm (n=129) (c,d). ZnS shells prepared at T_{H}=120° C.

### DETAILED DESCRIPTION OF THE INVENTION

Referring now to the drawings, wherein like reference numerals refer to like parts throughout, the present invention comprises a system and method for the hydrothermal and solvothermal synthesis of plasmonic and photoluminescent using a microwave assisted processing and synthesis route.

### Example 1

Cadmium perchlorate hydrate (99.999%), zinc perchlorate hexahydrate (>99%), sodium citrate tribasic dihydrate (>99%), bis (p-sulfonatophenyl) phenylphosphate dihydrate dipotassium salt (BSPP, >97%), Tellurium (>99.99%), Selenium (>99.99%), sodium borohydride (99.99%) were purchased from Sigma Aldrich. N, N-dimethylselenourea (97%) was obtained from Acros organics and sodium hydroxide was from Fisher scientific. Thioacetamide (>99.0%) was obtained from Fluka. In a typical synthesis, CdSe q-dots were synthesized at hydrothermal temperatures (T_{H}) with varied organic encapsulating ligands. Briefly, 0.25˜1.0 mL of 40 mM of cadmium perchlorate was added to 1˜1.8 mL of water. Then, 100˜300 ml of 0.1 M sodium citrate and 0.5˜1.0 mL of 20 mM of N,N-dimethylselenourea was added (5). For doing this, Cd and Se stock solutions were firstly prepared with ultra pure water (18.2 MΩ) and deaerated with nitrogen gas for 10 minutes. The solution was them hermetically sealed under N₂, and then processed in the microwave reactor for 2-10 at hydrothermal temperatures (T_{H}) ranging from 60˜180° C. To fine tune reaction conditions, ratios of Cd:Se:Cit molar ratio was differentiated.

The present invention promotes aqueous nucleation and growth of CdSe and CdTe q-dots by better control of hydrothermal synthesis. In the present invention, heat is transferred rapidly to the sample via dielectric heating achieved via microwave (MW) irradiation provided with varied power between 10-300 W operating at 2.45 gHz. Unlike traditional mantle or oil based heating, which rely on conduction, convection, and radiation, MW-based heating relies on energy transfer from MW electromagnetic radiation and the dipole moment of solvent, chemical, or material at high frequency (2-4). This “dielectric heating” acts simultaneously over the entire reaction volume, via transferring energy (10-300 W) selectively to only absorbing molecules, namely; metals, and dipole containing solvents or monomers. The interaction between a material and electromagnetic radiation is best described in terms of dielectric constants, as first investigated by Von Hippel (2). Briefly, energy transfer from the microwave electromagnetic radiation can be described as a dielectric loss e″, which is dependent upon a materials dielectric constant e′ (e′=eᵣe_{O}, eᵣ=dielectric constant, e_{O}=permittivity). A dissipation factor, tan g□=e″/e′ (g=loss tangent), then broadly defines a materials dielectric heating (2).

The strength of this approach is that MW power is dynamically attenuated by temperature feedback achieved by an integrated infrared detector or fiber optic probe. In addition, the instrument is equipped with an active pressure monitoring system, allowing for operating pressures 0-200 PSI.

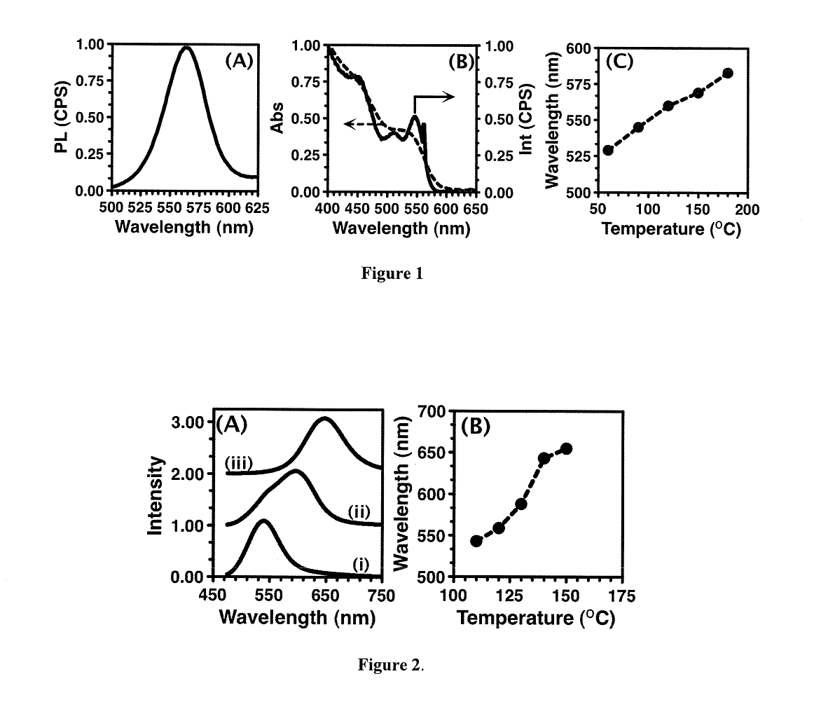

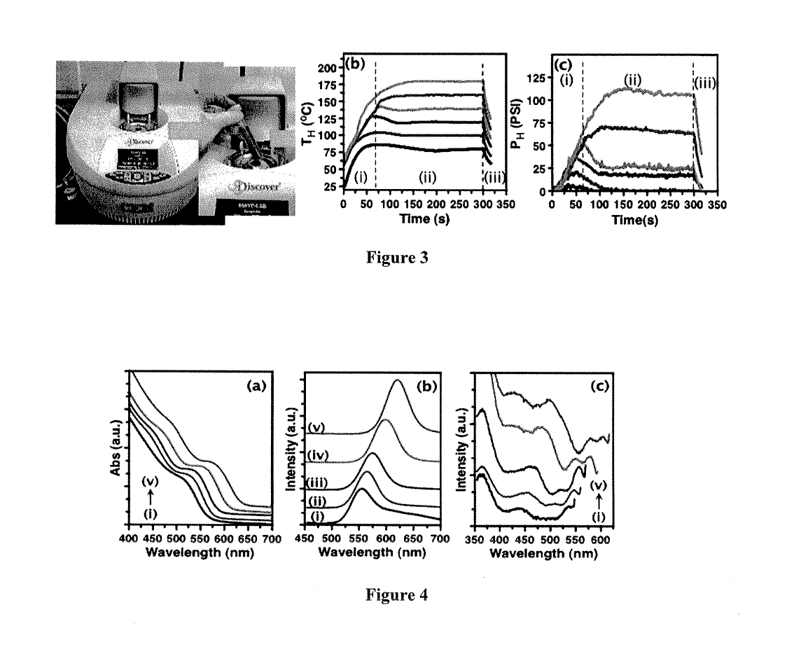

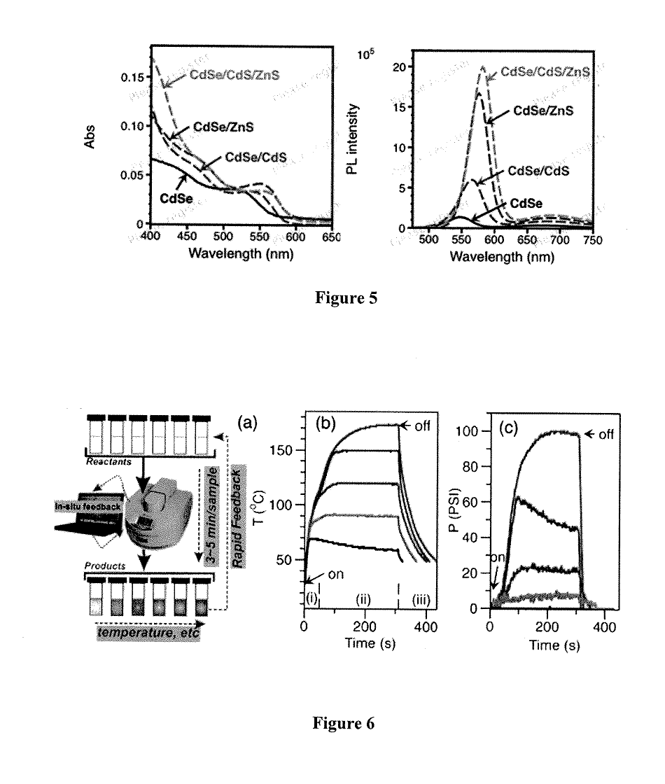

FIG. 1 shows representative photoluminescent emission spectra (PL, a), PL excitation spectra (b) and UV-visible absorption spectra (UV-vis, b), results for CdSe q-dots synthesized at 120° C. In this study, simple inorganic precursors of CdClO₄, NH₂CSeNH₂, and trisodium citrate (Cit) are combined at molar ratios of 1:X:Y (X=1-12, Y=5-100) in ultrapure water (18.2 MΩ) at pH=12 (5). In these studies all solutions were extensively deaerated with N₂ or Ar and hermetically sealed before heating. Temperature ramping to the desired T_{H} is achieved in only 30-120 sec. The observed emission, and electronic excitation is indicative of a reasonably monodisperse q-dot. Compared to other q-dots synthesized under aqueous conditions, the MAPS processed q-dot show intense color and fluorescence after only 2-5 min, compared to >24 hrs for q-dots prepared at reflux (5). Importantly, the q-dot size control was facilitated by the hydrothermal synthesis temperature (T_{H}). FIG. 1c shows the relationship between the PL emission peak with T_{H}, revealing a near linear dependence, after only 3 minutes of heating. For instance, the modest temperature of 90° C. reveals a PL emission of ˜564; while at T=150° C. (v) an emission at ˜598 nm is observed. Moreover, the PL excitation spectra reveal multiple energy levels, indicating high monodispersity (FIG. 1B). While not as electronically pure as their organic solvent based counterparts, these results suggest a high degree of core-size monodispersity, q-dot crystallinity, and lack of aggregation. This latter of which was confirmed via dynamic light scattering (DLS). A key factor of the approach of the present invention is the rapid hydrothermal heating being facilitated via the computer controlled MAPS. A remarkable characteristic of this is the emergence of intense color and optical signatures after only 30 seconds of heating, with high quality materials produced in only 2 minutes. In addition, longer heating times lead to further UV-vis and PL red-shift, indicating increased crystalline growth and ripening.

The approach of the present invention can be extended to a number of nanomaterials and q-dots, including CdS, and CdTe. FIG. 2a shows the PL emission of CdTe q-dots synthesized at 110 (i), 130 (ii), and 150 (iii) under similar conditions to those of CdSe. FIG. 2b shows the relationship between T_{H} and PL emission. Similar to the CdSe systems, we see a near linear increase in q-dot size with T_{H}. The PL emission spectra show FWHM that are larger than the CdSe, indicative of a broader size population. This is attributed in large part to the instability of the Te precursor employed, NaHTe, which is under current investigation.

The use of hydrothermal synthesis assisted by the use of a microwave reactor can be used to fabricate semiconductive q-dots in a rapid controllable MAPS protocol. Compared to the traditional methods, the present invention may provide a greener alternative due to the lack of organic solvents, the decreased reaction times, and decreased energy required to heat the samples quickly. The resulting CdSe show size tunability with increased hydrothermal temperatures, and photophysical properties that compare to organic solvent based analogues. These results show the MAPS based hydrothermal route to be a promising alternative.

The present invention also involves the fine-tunable hydrothermal synthesis of CdSe q-dots using microwave irradiation (MWI) as exemplified by the ease of growth of CdS or ZnS shells at the CdSe cores. CdSe q-dots were chose to illustrate the invention due to the wealth of structural information that can be obtained from their photophysical characteristics.

Referring to FIG. 6, the synthesis strategy of the present invention involves MWI based dielectric heating to hydrothermal temperatures allows for automated synthesis, high throughput, and in-situ monitoring of reaction temperature (b), and pressure (c) during hydrothermal q-dot synthesis. FIG. 6 shows an idealized illustration of the automated MWI based synthesis set-up employed (a), as well as the in-situ temperature (b) and pressure (c) profiles obtained during a typical synthesis of CdSe q-dots at temperatures of 60-180° C. MWI heating is computer controlled, with MW power being dynamically attenuated by temperature feedback measured via an integrated infrared detector or fiber optic probe, allowing for control of heating and cooling rates.

Since both heating and cooling rates are rapid, this protocol can produce materials in a generally high-throughput manner, with the potential for automation. FIG. 6b shows the rapid increase in hydrothermal temperature (T_{H}) to a desired set-point (region-i), followed by a stable annealing temperature (region-ii), and the rapid temperature quenching (region-iii) due to absence of MWI coupled with high flow rate purging of the MW cavity by compressed N₂. A similar profile is shown for the systems pressure characteristics (FIG. 6c).

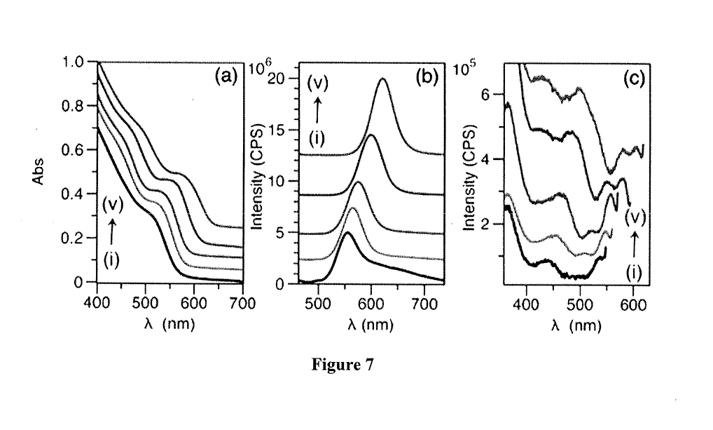

There is seen in FIG. 7 representative UV-visible absorption (UV-vis, a), photoluminescence emission (PL, b) and PL excitation spectroscopy (c) results for the CdSe q-dots synthesized at 60 (i), 90 (ii), 120 (iii), 150 (iv), and 180° C. (v). Cadmium perchlorate was first complexed with trisodium citrate (Cit) at pH-12 in deareated ultrapure water (18.2 MΛ) forming the Cit-Cd complex precursor. While seemingly benign, Cit possesses a rich set of complexation chemistry with transition metals, such as with titanium, and provides a stable Cd²⁺ precursor. Next, an aqueous aliquot of freshly prepared, deareated, selenourea is added at molar ratios (r=[Cd]/[Se]) of 4 or 8, with a concentration of Cit of 1-4r. Prior to heating, the precursor solution was rapidly deaerated with N₂ or Ar, and hermetically sealed in glass reaction vessels equipped with stirring capability. The annealing time was held constant for each synthesis at 5 minutes.

The observed UV-vis and PL red-shift with increasing T_{H} (i-v) in FIG. 7 is consistent for an increase in q-dot diameter (d) from ≈2.5 (i) to ≈4.0 nm (v). Here, nearly identical temperature ramping (1˜2° C./s) was utilized, providing comparable kinetic growth pathways between samples. As expected, CdSe prepared at low temperature possessed poor optical properties. At a modest T_{H}=60° C. (i) a first band edge absorption of 526 nm and PL emission of 564 nm is observed. A slight improvement was observed T_{H} is increased to 90° C. (ii), where a symmetric band edge emission emerges with a FWHM of ˜45 nm and is accompanied by a second emission at lower energy (≈625 nm), indicating either a polydisperse size distribution, a strong trapped-state emission due to poor crystallinity, or a combination thereof. In contrast, CdSe prepared at elevated T_{H} (>120° C.) show much improved emission properties. When prepared at T_{H}=180° C. (v) the q-dots reveal a symmetric band edge emission with decreased FWHM of 35˜40 nm, and lack of trap emission, thus demonstrating improved monodispersity and crystallinity. The improved monodispersity is apparent in the observed PL excitation measurements (FIG. 7c), with CdSe prepared at high T_{H} possessing increasing numbers of distinguishable energy levels.

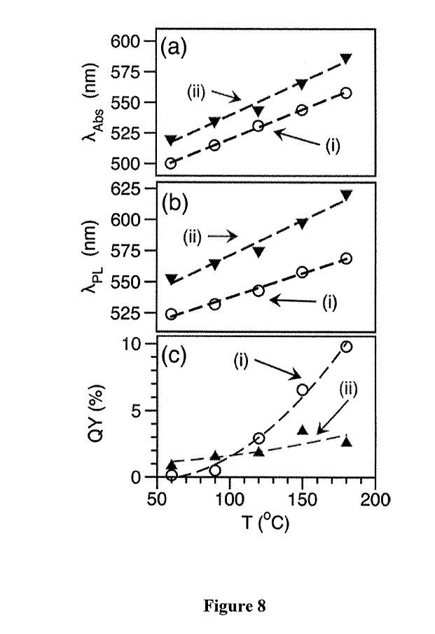

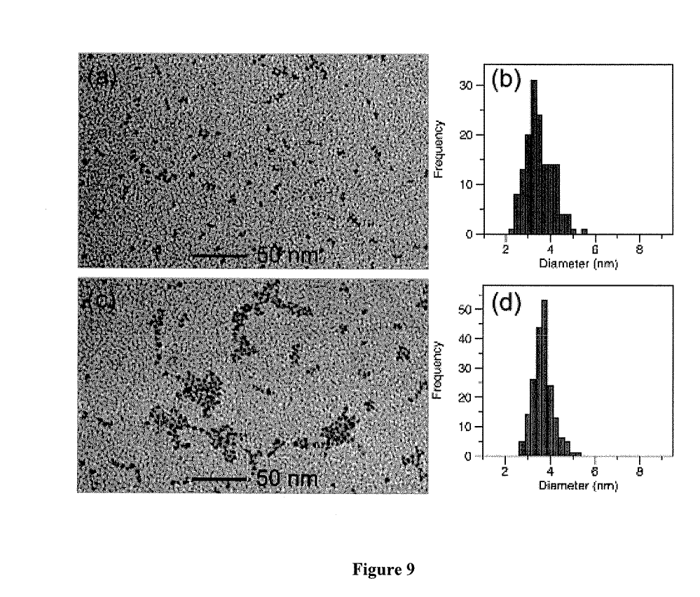

The q-dot size range and its dependence on T_{H} was further tailored by r. For instance, when the r was increased from 4 to 8, we observed a decrease in the q-dot size at identical T_{H} and reaction times. Interestingly, we also observed a decrease in FWHM to nm at T_{H}>120° C. FIG. 8a-b summarizes these results and reveals a near linear dependence of first band edge absorption (a) and Stoke shifted PL emission wavelength (b) with T_{H}. A decrease in FWHM indicates further improvement in q-dot quality, especially in terms of monodispersity and crystallinity. This was further substantiated via Transmission Electron Microscopy (TEM). FIG. 9 shows representative TEM micrographs of CdSe prepared at 120° C. (a) and 180° C. (c) with r=8. Statistical analysis of the q-dots (FIG. 9b,c) reveals a modest size distribution of 3.4±0.6 nm when prepared at 120° C., whereas an increase in diameter and narrowing of distribution to 3.8±0.4 nm is measured at 180° C. These diameters are in close agreement with the corresponding optical properties, and also reveal the q-dots to have highly truncated morphology.

To quantify the improved optical properties of the hydrothermally prepared q-dots, the PL quantum yield (QY) was carefully calculated. FIG. 8c shows the calculated QY for the CdSe prepared at both r of 8 (i) and 4 (ii). We observed a dramatic increase in QY for CdSe prepared at T_{H}>120° C. when synthesized at r=8, which typically have higher QY than the r=4 counterparts. For instance, q-dots prepared at 60-100° C. consistently have QY of only ˜1% directly after synthesis, whilst samples prepared at T_{H}≧120° C. showed consistent increases of ≈3.0, ≈6.6, and ≈9.9% when prepared at 120, 150, and 180° C. respectively at r=8. These QY values in particular are high for CdSe, especially for those synthesized via aqueous protocols. An improved QY is indicative of high core crystallinity, and a decrease in surface defects of a q-dot. Such structural insights can be best investigated by lifetime measurements, as described next.

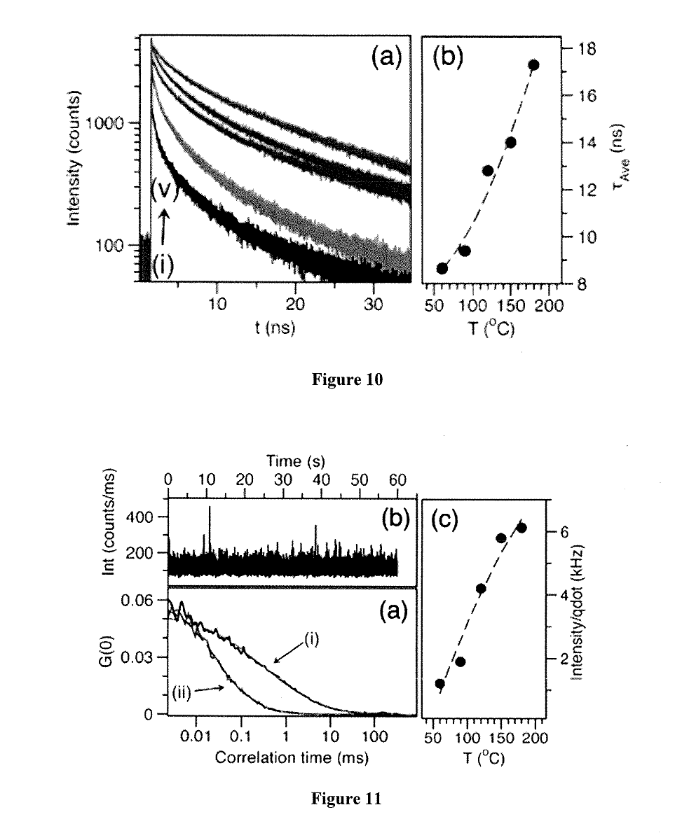

To further probe the photophysical properties of the hydrothermally prepared q-dots, time correlated single photon counting (TCSPC) experiments were conducted to probe characteristic PL decay. The TCSPC delay signatures for q-dots synthesized at r=8 and T_{H} of: 60 (i), 90 (ii), 120 (iii), 150 (iv), and 180° C. (v) are shown in FIG. 10a. From these PL decays, it is evident that CdSe prepared at high T_{H} posses longer lifetimes (τ) with a more pronounced single exponential character. The PL decay was first modeled as a triexponential response (τ₁+τ₂+τ₃) and the results of the least squares fitting is listed in Table 1 below.

TABLE 1
Analysis of QY, TCSPC, and FCS fitting for CdSe and CdSe/ZnS qdots.

| | | PL | | TCSPC³ | | | | FCS⁴ | |
|---|---|---|---|---|---|---|---|---|---|
| | T_{H} | λₘₐₓ | QY² | t₁/ns | t₂/ns | t₃/ns | tₐᵥₑ | D | PL |
| | (° C.) | (nm) | (%) | (%) | (%) | (%) | (ns) | (mm²/s) | (kHz) |
| CdSe¹ | 60 | 529 | 0.14 | 13.2 | 1.88 | 0.018 | 8.65 | 24.3 | 1.21 |
| | | | | (69%) | (25%) | (6%) | | | |
| | 90 | 545 | 0.50 | 13.2 | 2.20 | 0.081 | 9.40 | 29.2 | 1.89 |
| | | | | (66%) | (30%) | (4%) | | | |
| | 120 | 560 | 2.94 | 16.8 | 3.39 | 0.246 | 12.8 | 23.9 | 2.12 |
| | | | | (77%) | (21%) | (2%) | | | |
| | 150 | 569 | 6.58 | 17.4 | 3.43 | 0.239 | 14.0 | 24.5 | 5.9 |
| | | | | (77%) | (22%) | (1%) | | | |
| | 180 | 583 | 9.81 | 19.7 | 4.07 | 0.281 | 17.3 | 28.8 | 4.86 |
| | | | | (84%) | (15%) | (1%) | | | |
| CdSe/ZnS | 120/120⁵ | 557 | 38.00* | 20.4 | 6.93 | — | 19.5 | 35.4 | 8.13 |
| | | | | (93%) | (7%) | | | | |

¹CdSe in these studies were prepared at r = 8 exclusively.
²QY calculated by comparison to dye standard using equation 3.
³TCSPC fitting performed using multiexponential decay models of decay histograms with correction for the instrumental response function (~45 ps) using equation 1. Individual lifetimes (τ₁, τ₂, τ₃) are shown with intensity weighted percentages, which can be used to estimate average lifetime τₐᵥₑ.
⁴FCS correlation curves were fit using a standard triplet diffusion model using equation 2.
⁵CdSe cores prepared at 120° C., followed by ZnS shell growth at 120° C.

For example, the CdSe prepared at T_{H}=90 (ii) possessed lifetimes with decays of τ₁≈13, τ₂≈2.1, and τ₃≈0.08 ns, with intensity weighted percent contributions of 69%, 25%, and 6% respectively, indicating the strong influence of surface trapping by the increased ultrafast contributions (τ₂, τ₃). To the contrary, q-dots prepared at T_{H}≧120 (iii-v), revealed longer lifetimes with high τ₁ contributions. For instance, τ₁ of 17.4 (77%) and 19.4 ns (84%) were measured from q-dots prepared at T_{H}=150 and 180° C. respectively. To better compare results, an intensity weighted average PL lifetime (τ_{Ave}) was calculated. As shown in Table 1 above, a τ_{Ave} of; 8.6, 9.4, 12.8, 14.0, and 17.3 ns are calculated for CdSe prepared at 60, 90, 120, 150, and 180° C., respectively. FIG. 11b summarizes the results, and shows the significant increase in τ_{Ave} with T_{H} according to:

$${τ}_{Ave} = \frac{1}{Γ + Σ {k}_{NR}} \qquad ( 4 )$$

The fluorescent τ of a molecule or material provides valuable insights into the electronic structure, and is inversely proportional to the sum of emission rate (Γ) and the sum of non-radiative decay rates (kₙᵣ),⁶⁴ as shown ideally in equation (4) above. If we make the assumption that Γ is unchanged in the q-dots due to the identical composition, excitation, environment (shell & solvent), then the increase in τ_{Ave} for q-dots synthesized at high T_{H} is indicative of a decrease in kₙᵣ. Here, kₙᵣ is taken to be the sum of multiple decay channels. A number of factors are known to influence q-dot kₙᵣ, including composition, band structure (diameter, shell type), crystallinity, and surface trapping type. Taken together, along with the increase in diameter, the increase in τ_{Ave} and the corresponding single exponent contribution, is indicative of a well-defined band structure and decrease in crystalline or surface defects. This provides further evidence of the improvement of CdSe at high hydrothermal temperatures. In addition, the ultrafast component is likely also influenced by exciton-solvent interactions, given the weak encapsulating shells, and the polar media (water) employed.

Referring to FIG. 6, there is seen a representative set of FCS results for CdSe q-dots fabricated at 150° C. (i) and a Rhodamine 110 (ii) standard normalized to q-dot concentration (a). Fitting with a triplet diffusion model results in <N>˜17 q-dots in the focal volume during measurement, with a diffusion constant <D>˜24.5 mm2/s. Compared with corresponding intensity time traces (b), average q-dot brightness is estimated. A corresponding plot of the trend between q-dot brightness and processing temperature (c).

Q-dot photophysical characteristics can also be probed at the single-q-dot level, using fluorescence correlation spectroscopy (FCS). FCS probes diffusion constants (<D>) for the q-dot emitters, as well as quantifying the number of emitters (N) in a known confocal volume.68 Combined with intensities obtained from time traces, one can obtain average single q-dot brightness (counts/N). Q-dot brightness, as well as PL intermittency (i.e. blinking) provides further insights into photophysical behavior. FIG. 6 shows a representative FCS trace for a CdSe q-dot prepared at TH-150° C. compared to a Rhodamine standard. When analyzed via equation 2, a <D> of 24.5 μm2/s and N of ≈17 was calculated, corresponding to a brightness of 5.9 kHz (counts/ms). FIG. 6c reveals the brightness dependence on TH. Compared to q-dots synthesized at TH<100° C. with brightness between 1˜2 kHz, those prepared at TH>120° C. revealed a systematic increase in brightness to >5 kHz. In addition to brightness, FCS provides information pertaining to the q-dot emitter hydrodynamic diameter (Dh) via the measurement of diffusion constants. Average Dh values obtained from FCS reveal Dh≈6 nm, which are in good agreement with the q-dot sizes and the thin Cit-encapsulating layer. This value is important, as a number of studies have shown the importance of small q-dot Dh on applications in bioimaging and in-vivo transport. It was recently shown that NIR emitting q-dots with thin encapsulating shells of mercaptopropionic acid (MPA) can facilitate effective transport in mice models for tumor imaging.

While the size tunability and photophysical properties of the hydrothermally prepared q-dots are promising, further steps must be taken to improve QY to the 30-50% range before they can find utility in a number of applications. To further improve QY, steps must be taken to limit exciton surface trapping sites and exciton-solvent interactions. This is best achieved by epitaxially encasing the CdSe core within a larger band-gap semiconductor, such as CdS, ZnS, and combinations thereof. This step passivates the unsaturated surface dangling bonds, and sequesters excitons within the core.67 Our MWI-based hydrothermal method also facilitates this approach.

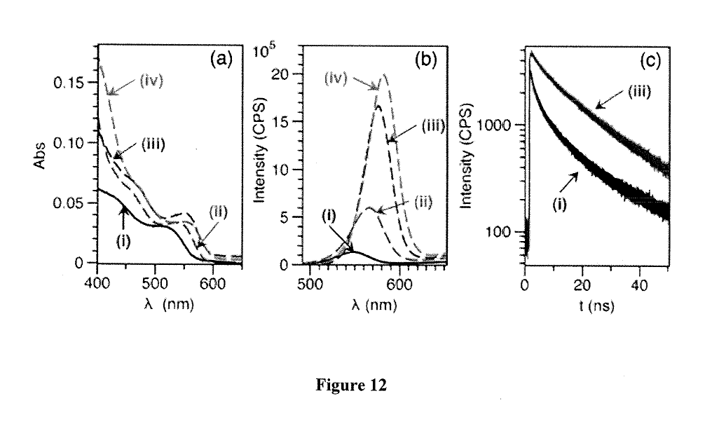

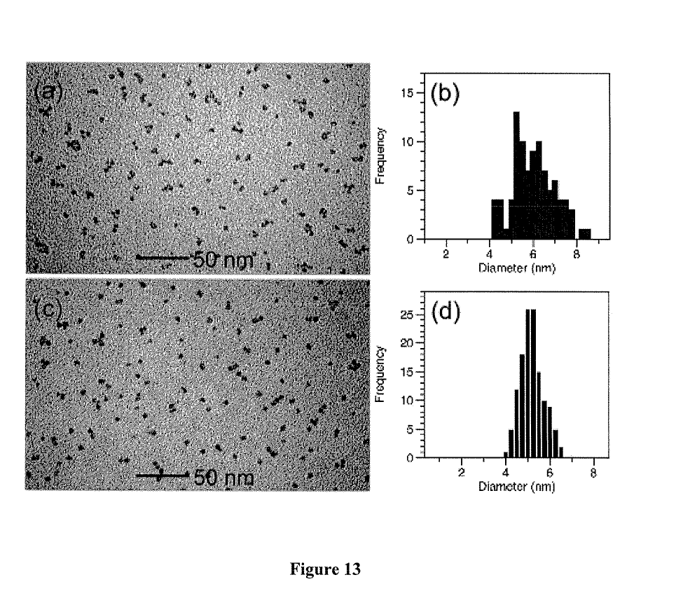

FIG. 12 shows the optical characteristics after growth of CdS (i), ZnS (ii), and CdS/ZnS (iii) shells at CdSe cores. Briefly, CdSe cores were fabricated at TH>120° C. at r=8, and then re-processed in the presence of either sulfur precursors, or sulfur and zinc precursors at TH>120° C. Successful shell growth was confirmed by UV-vis (a) and PL emission (b), which showed characteristic red shifts, and notable increases in QY from ≈3% to 20-40%, depending upon conditions such as r, as well as sample annealing time. This increase in QY is complemented by an increases in Ave from 12.8 nm to 19.5 ns (FIG. 7c), and a FCS measured brightness increase from ≈2.1 to ≈8.3 kHz for CdSe/ZnS q-dots (Table 1). Shell growth was confirmed by TEM. A set of representative TEM micrographs from CdSe/ZnS q-dots are shown in FIG. 13 after shell growth at T_{H}=120° C. at CdSe cores synthesized at 120 (a) and 180° C. (c). Compared to the core and (FIG. 9), core/shell diameters increased to 5.9±1.0 nm (b), and 5.2±0.5 (d) respectively. These results show that q-dot monodispersity is largely retained even after a relatively thick ZnS is grown. The higher dispersity for the cores prepared at 120° C. may be due to the initially higher core polydispersity, slight variation in growth conditions and concentrations, or increased faceting and shape, the latter of which is challenging to account for at the current resolution.

### Example 2

Chemicals: Cadmium perchlorate hydrate (Cd(ClO₄)₂, 99.999%), zinc perchlorate hexahydrate (Zn(ClO₄)₂, >99%), sodium citrate tribasic dihydrate (Cit, >99%) was purchased from Sigma. N,N-dimethylselenourea (Me₂NCSeNH₂, 97%) was obtained from Acros organics and sodium hydroxide was from Fisher scientific. Thioacetamide (MeCSNH₂, >99.0%) was obtained from Fluka. Ultrapure water (18.2 MΛ) was provided from a Sartorius Stedim Arium 61316 reverse osmosis unit combined with a Arium 611DI polishing unit. All chemicals were used as received.

Synthesis: The synthesis of CdSe quantum dots (qdots) as well as CdSe/ZnS, CdSe/CdS, and CdSe/CdS/ZnS core/shell qdots was carried out in an aqueous system using well-defined hydrothermal temperatures (T_{H}). Here, T_{H} is achieved using a synthetic microwave reactor (Discovery-S, CEM Inc.) that facilitated rapid heating, stable set-points, and temperature quenching.

CdSe Qdots: The precursor chemicals and initial synthesis ratios were inspired by Kotov and co-workers,⁸⁻⁹ and used with modification. In a typical synthesis, an aliquot (0.25˜1.0 mL) of 40 mM of Cd(ClO₄)₂ was diluted in 1˜1.8 mL of ultrapure water (18.2 MΩ). Next, an aliquot (100˜300 μl) of 0.1 M Cit and 20 mM of Me₂NCSeNH₂ (0.5˜1.0 mL) was added. Before dilution, the freshly prepared Cd and Se stock solutions were prepared with ultra pure water and deaerated with N₂. Finally, the pH was adjusted to by addition of 1.0 M NaOH. The final solution was then sealed in 10 mL glass microwave reaction vials, hermetically sealed, and purged via N₂ before MWI processing. In a typical experiment, the total heating time at the desired hydrothermal set point (120˜180° C.) was 2 minutes. A number of synthetic parameters were varied to best optimize and tailor the nucleation and growth in MAPS. A main parameter is the synthetic ratio r, r=[Cd]/[Se]. Here, we show the results of r=4 and 8. In general, we found that r=4 leads to greatest T_{H} dependent size tunability, where r=8 results in qdots with higher QY.

In initial experiments, synthesis was carried out in 3-10 mL scales. The synthesis was then extended to 25-30 mL scales without significant changes to the qdot characteristics, owing in large part to the direct dielectric heating the MW provides. Moreover, changes to scale do not dramatically alter heating or cooling kinetics.

Core/Shell Qdots: For the preparation of core/shell CdSe/CdS, CdSe/ZnS, and CdSe/CdS/ZnS qdots, the as-synthesized Cit-capped CdSe qdots synthesized above were combined with MeCSNH₂ as a sulfur source and Zn(ClO₄)₂ as a zinc source in quantities required to epitaxially grow a 2-4 monolayer ZnS shell. Briefly, to the 1.5 mL of CdSe qdot solution of known concentration, 50˜150 μl of 20 mM MeCSNH₂ was added, depending upon core concentration (calculated using the first absorption maxima)⁶², and desired shell thickness, and then purged with N₂. Next, the sample was hydrothermally processed for 2 min at either 120 or 160° C. In this case, the excess Cd²⁺ from core growth is also used for shell formation. For the growth of ZnS shells, 50˜150 μL of 20 mM of zinc perchlorate was added to the CdSe qdots, in which the excess Cd²⁺ was first removed by ion exchange filtration using 10 KDa molecular weight cut-off centrifugation filter and redispersed in the 6.0 mM sodium citrate solution with pH=10. Next, the sample was then processed for 2 min at hydrothermal temperatures of either 120 or 160° C.

The qdots were typically stored in the synthesis mother liquor, however purification could also be performed via overnight dialysis using a 500 Da membrane (Spectrum Laboratories Inc.). The qdot QY was found to increase dramatically at hydrothermal processing temperatures (T>120° C.). However, we also observed the slow increase in QY over 10-50 days, due to an aging and self-annealing process. Such an annealing process was recently described⁸⁻⁹, and likely involves the photoactivated annealing of qdot surface, resulting in less surface defect sites, as well as the potential growth of thin layers of higher bandgap CdO shells.

Instrumentation

Synthetic Microwave Reactor: A Discovery-S (CEM Inc) synthetic microwave reactor was employed. The instrument is computer controlled, and operates at 0-300 W, from 30-300° C., and from 0-200 PSI. Temperature is monitored in-situ during synthesis via the use of an integrated IR-sensor, or via an immersed fiber optic temperature probe. The instrument is equipped with an active pressure monitoring system, which provides both pressure monitoring and added safety during synthesis. Pressure rated glass reaction vials with volumes of 10 or 35 mL were employed during synthesis. Active cooling was provided by the influx of the MW cavity with compressed N₂, which rapidly cools the sample at a controlled rate.

UV-visible Absorption (UV-vis): The UV-vis measurements were collected on a Varian Cary100 Bio UV-vis spectrophotometer between 200-900 nm. The instrument is equipped with an 8-cell automated holder with high precision Peltier heating controller.

Photoluminescence (PL): The PL emission and excitation measurements were collected on a Fluoromax-4 photon counting spectrofluorometer (Horiba Jobin Yvon). The instrument is equipped with a 150 W xenon white light excitation source and computer controlled monochromator. The detector is a R928P high sensitivity photon counting detector that is calibrated to emission wavelength. All PL emission and excitation spectra were collected using both wavelength correction of source intensity and detector sensitivity. The excitation wavelength is 400 nm using 3 nm excitation and emission slits unless otherwise noted, and excitation spectra were collected at the qdot emission peak using 1 nm excitation and emission slits. The instrument is equipped with a computer-controlled temperature controller provided by a Thermo NESLAB temperature recirculator (Thermo Scientific).

Transmission Electron Microscopy (TEM): TEM measurements were performed on either a FEI T12 Twin TEM operated at 120 kV with a LaB6 filament and Gatan Orius dual-scan CCD camera (Cornell Center for Materials Research), or a JEOL 2000EX instrument operated at 120 kV with a tungsten filament (SUNY-ESF, N.C. Brown Center for Ultrastructure Studies). Particle size was analyzed manually by modeling each qdot as a sphere, with statistical analysis performed using ImageJ software on populations of at least 100 counts.

Time Correlated Single Photon Counting (TCSPC): The TCSPC measurements were performed at Brookhaven National Laboratory (BNL) in the Center for Functional Nanomaterials (CFN) facility. Photoluminescence decays were measured by the time-correlated single photon counting (TCSPC) method by using 420 nm pulsed laser excitation. The setup is based on a frequency doubled diode-pumped Ti:sapphire laser system (Newport Spectra Physics, 8 MHz repetition rate, 60 fs pulse width) and a Fluotime 200 time-resolved fluorescence spectrometer (Picoquant GmbH). Fluorescence decays were collected at magic angle in the spectral range 520-600 nm, detected by a microchannel plate photomultiplier (Hamamatsu, 25 ps response) and registered by a TCSPC module (Picoharp 300, Picoquant GmbH). Decay histograms were collected with a time resolution of 4 ps per channel and analyzed by reiterative convolution of the instrumental response function (45 ps) with an exponential model (equation 1) function using the FluoFit software (Picoquant, GmbH).

$$I ( t ) = {\int }_{- ∞}^{t} IRF ( {t}^{′} ) {\sum }_{i = 1}^{n} {A}_{i} exp ( - \frac{t - {t}^{′}}{{τ}_{i}} ) d {t}^{′} \qquad ( 1 )$$

Fluorescence Correlation Spectroscopy (FCS): Fluorescence correlation spectroscopy (FCS) was performed at the CFN in BNL. FCS was performed with a homemade confocal fluorescence microscope based on an Olympus IX 81 microscope (1.2 NA 60× water immersion lens) by using the 457 nm laser light from an Ar-ion laser (Melles-Griot, 10 μW average power at the sample). Photoluminescence emitted by freely diffusing qdots was collected by the same lens, spectrally filtered from excitation by a dichroic mirror (DRLP455, Omega Filters) and a band bass (HQ605/40, Omega Filters) and imaged, via a 75 μm pinhole and a 50/50 beam splitter, onto two single photon counting avalanche photodiodes (MPD, Picoquant GmbH, Germany). FCS (intensity correlation) curves were acquired in cross-correlation mode using a real-time hardware correlator (time-correlated single photon counting analyzer, PicoHarp300, Picoquant GmbH, Germany). Autocorrelation data (AC(τ)) were recorded for 1 minute and collected and processed using SymPhoTime software. FCS curves were then fit via a simple model accounting for 3D diffusion and blinking (eq. 2):

$$AC ( τ ) = {N}^{- 1} ( \frac{1}{( 1 + τ / {τ}_{Diff} ) {( 1 + τ / {( {r}_{0} / {ω}_{0} )}^{2} {τ}_{Diff} )}^{1 / 2}} [ 1 + ( {F}_{T} / ( 1 - {F}_{T} ) ] exp ( - τ / {τ}_{T} ) \qquad ( 2 )$$

where N is the average number of molecules in the confoca volume, τ_{Diff} is the diffusion time, r₀ and ω₀ are the radial and axial dimensions of the excitation volume, and F_{T} and τ_{T} are the fraction of molecules in the triplet state and the triplet lifetime, respectively. Diffusion coefficients and hydrodynamic radius (r_{H}) were estimated by using the Stokes-Einstein equation. A structural parameter related to the probe volume was estimated based on FCS measurements of rhodamine 110 in water.

Calculations:

The qdot concentration were calculated based on UV-vis optical absorption measurements of the qdot first band edge absorption (1s−1s) intensity using qdot size dependent optical extinction coefficients (∈_{qdot}). Qdot size was correlated to absorption wavelength using the Peng calibration method⁶², which was then used to estimate ∈_{qdot}. For instance, a CdSe qdot with band edge absorption of 555 nm corresponds to a core diameter ≈3.2 nm, which in turn determines the ∈_{qdot}=1.9×10⁵ cm⁻¹M⁻¹. The final qdot concentration was then obtained using the Beers-lambert relationship Abs=∈bc; where ∈ is the estimated extinction coefficient (M⁻¹ cm⁻), b is the path length, and c is concentration.

The qdot photoluminescence quantum yields (QY) were calculated based on comparison to a reference dye using standard methods⁶⁴, using equation 3:

$${QY}_{qdot} ( \% ) = {QY}_{R} ( \frac{{Abs}_{R}}{{Abs}_{qdot}} ) ( \frac{{PL}_{qdot}}{{PL}_{R}} ) ( \frac{{η}_{qdot}^{2}}{{η}_{R}^{2}} ) \qquad ( 3 )$$

where QY_{R} is the reference dye quantum yield (Rhodamine=31%, Rhodamine 6G=95%), Abs_{R} and Abs_{qdot} are the optical absorption at specific excitation for the reference dye and qdot samples respectively. Here, careful attention was paid to prepare samples with optical absorption below 0.05-0.10 in order to limit inner filter effects.⁶⁴ PL_{R} and PL_{qdot} correspond to the total area of the PL emission after wavelength dependent calibration of both the excitation source, and photoluminescence detector, as well as after PL spectra baseline correction. The emission is fit to a Gaussian profile. For samples exhibiting a trap-state emission (lower energy), only the band-edge emission PL area is used in QY calculations. The refractive index of the reference and qdot solvent, η_{R} and η_{qdot}, where also taken into account when required.

These results show that the q-dot synthesis under aqueous processing is greatly facilitated by the presented MWI based hydrothermal protocol. The increased throughput and processing temperature allows for size control, narrowing of size distributions, and improved quantum yields. The resulting core and core-shell q-dots are bright and posses small hydrodynamic diameters. Work is still needed in order to optimize all conditions, and broaden the protocol for additional q-dot classes, such as alloyed q-dots, and Cd-free d-dots. Nevertheless, the size control, and high quantum yields show promise for the tailorable hydrothermal processing of q-dots, the method of which may be adapted for other nanomaterials. An added novelty of these q-dots is the accessible q-dot interface, which facilitates ligand exchange and biofunctionalization, which may aid in biomimetic self-assembly and FRET based sensing and imaging, all part of our ongoing work.

What is claimed is:

1. A method of forming quantum dots, comprising the steps of:
dissolving at least one precursor dissolved in ultrapure water to form an aqueous solution;
deaerating the solution using nitrogen; and
heating the solution with microwave irradiation for a predetermined time.

2. The method of claim 1, wherein the step of heating the solution with microwave irradiation for a predetermined time comprises heating with microwave generator having a power rating of between 10 watts and 30 watts at 2.45 gHz.

3. The method of claim 2, wherein said predetermined time comprises between 2 and 10 minutes.

4. The method of claim 1, wherein the step of the step of heating the solution with microwave irradiation for a predetermined time comprises heating the solution to a temperature of 60 to 180 degrees Celsius.

5. The method of claim 4, wherein said temperature is 120 degrees Celsius.

6. The method of claim 1, further comprising the step of hermetically sealing the solution under nitrogen prior to the step of heating the solution.

7. The method of claim 1, wherein the step of heating the solution with microwave irradiation for a predetermined time comprises dynamically attenuating the microwave power using temperature feedback to control the rate of heating.

8. The method of claim 1, wherein said at least one precursor comprises cadmium.

9. The method of claim 1, wherein said at least one precursor comprises selenium.

10. The method of claim 1, wherein said at least one precursor comprises tellurium.

11. The method of claim 1, wherein said at least one precursor comprises zinc.

12. The method of claim 1, wherein said at least one precursor comprises sulfur.

13. The method of claim 1, wherein said at least one precursor comprises iron.
